(19) United States
(12) Patent Application Publication
(10) Pub. No.: US 2016/0242991 A1
(43) Pub. Date: Aug. 25, 2016

(54) Therapeutic Back Scratcher

(71) Applicant: Warren Matthew Johnson, Tempe, AZ (US)

(72) Inventor: Warren Matthew Johnson, Tempe, AZ (US)

(21) Appl. No.: 14/630,517

(22) Filed: Feb. 24, 2015

(51) Int. Cl. A61H 7/00

(52) U.S. Cl. CPC A61H 7/003; A61H 2205/081

(57) ABSTRACT

A back scratcher consists of protrusions on each side of its head allowing it to be capable of activating pressure points along the user's back for therapeutic relief in addition to relieving one's itch.

### BACKGROUND OF THE INVENTION

1. Field of the Invention

The present invention relates generally to back scratchers, and more particularly to back scratchers with a therapeutic purpose based on the activation of pressure relief points.

2. Description of Related Art

The purpose of this invention is to fulfill the need of a therapeutic back scratcher (TBS), which is non-existent today. The need to scratch one's back exists throughout a person's lifetime. Babies and the elderly alike are soothed by another's touch to the back. Relief is achieved when one has the ability to scratch an irritating itch. Itches occur in all areas of one's back but one can only reach to limited areas on their own back. Therefore, in order to achieve gratification and relief to scratch an itch located beyond one's reach, one must either seek out another individual to have them scratch their back or find an appliance to address the need. Such a device is described by Wright in US patent application US 2006/0253054 A1.

A thorough review of prior art demonstrates the differences in the present device as a back scratcher with therapeutic purposes. The specific problems in the prior art deal with covering greater areas to scratch one's itchy back but miss out on the opportunity to provide therapeutic pain relief via focused access to and activation of pressure relief points as understood by massage acupuncturists and Shiatsu practitioners. Applying pressure to a single point, or along meridian lines, makes this a tool for acupressure points on the human body, such as the back, that cannot be easily reached with the user's hand.

The present invention's use of double radius teeth at the end of the device head allow the user to control the number and position of points that come in contact with the human back to relieve the itch while ensuring minimal likelihood of inducing trauma to the skin. Additionally, the present invention incorporates a tooth on each side of the device head to allow the user access to therapeutic/ancient Asian pressure relief points on the back in a manner similar to massage acupuncture techniques. Nothing known to the applicant in the prior art utilizes the unique combination of features and structural parameters of applicant's invention.

In sum, from the observation of the present invention and the prior art, it can be shown that use of this invention provides a greater utility to the user to control the number of teeth contacting the skin in a safe and effective manner for both basic itch relief and pressure points for therapeutic relief.

### SUMMARY OF THE INVENTION

The therapeutic back scratcher is a hand held and hand operated device comprising a long rigid stem affixed with a head on its distal end as a means to engage the human back. The elements of the invention solve problems in the prior art including the ability of the user to selectively choose the area of relief on one's back during the scratching process. Also in absence in the prior art is the ability to turn a back scratcher on its side to utilize additional features on the back scratcher to impart pressure along the body's meridian lines.

In operation of the present invention the proximal end shaft is grasped by the user's hand, who then reaches over their back or behind their shoulder to press the distal end with the back scratcher's teeth against their back. The novel design of a double radius scratching head where the face is at one radius and the underside of the teeth from one end of the back scratcher to the other form another arc make it possible to massage the back with one to seven teeth because of the shape and configuration of the teeth. The user can change the number of teeth applied to the back by changing the angle of the handle while using the scratcher. This configuration gives the user a way to scratch or apply pressure at a single pressure point to improve overall well being or to remove an itch that would still be there after a general massage of the back with seven teeth. The radius of the end of the teeth are such that tissue trauma due to motion and engagement (such as digging in) is minimized, providing a surface which more readily fits with the varying curvature of the human back. Depending upon the relief sought, the user then imparts a reciprocating motion over the itch, or if desired, turns the TBS on its side and applies pressure along the medial lines for soothing therapeutic relief.

For thousands of years, the Chinese have practiced acupressure point stimulation to relieve pain and to improve the feeling of overall well being. The TBS gives the user the opportunity to apply pressure to those pressure points on the back that cannot be reached by the user's hands, while also allowing strong pressure to be applied. The pressure should be somewhere between pleasant firm pressure and pain.

Due to the engagement of acupressure points, the user may feel slight pain or tingling in other parts of the body when applying pressure to a single point. The user needs to apply pressure to these related areas as well to release blockages and increase a feeling of well being. In addition to the physical product of the therapeutic back scratcher, there are specific instructions to direct the user to access and activate these pressure points.

### OBJECT OF THE INVENTION

It is therefore the object of this invention to introduce a therapeutic back scratching device that for a relatively low cost duplicates not only a common back scratching experience but a therapeutic one as well.

It is yet another object of this invention to provide a back scratcher that has the general appearance of a long handled garden cultivator tool with a solid pie shaped head made of lightweight material.

It is yet another object of this invention to provide a back scratcher that has a plurality of teeth sequentially decreasing in length from the center tooth outward in a saw-tooth configuration which extend orthogonally from the distal end of the head forming the scratching surface.

It is yet another object of this invention to provide a head on the back scratcher with a protrusion on each side that is capable of activating pressure points along the user's back allowing for therapeutic relief.

It is yet another object of this invention to provide for a head of the back scratcher to incorporate a double radius design to smoothly scratch the itching area by allowing the user to rock the scratching head via axial rotation of the handle.

### BRIEF DESCRIPTION OF THE DRAWINGS

The attached drawings are included to provide additional understanding of the invention and are to be considered part of this description that illustrates the embodiments of the invention, and together with the detailed description provide an explanation of the principles of the invention.

Wherein the drawings:

FIG. 1 is a perspective view of the present invention from the front and side, showing the handle, head, downward protruding and side protruding teeth.

FIG. 2 is a perspective view of the present invention from the underside, showing the teeth protruding up from the bottom side.

FIG. 3 is a perspective view of the present invention from the top side showing in particular the teeth protruding from the side at the front of the scratching head.

FIG. 4 is a perspective view of the present invention from the side showing the slight downward angle of the scratching head from the handle and the curvature of the front face of the scratcher head

FIG. 5 is a perspective view of the present invention from the front showing the face of the scratcher head with the teeth protruding downward and how the length of the teeth progressively are shortened in a symmetric manner about the central tooth.

FIG. 6 is a perspective view of the present invention showing a side view of one of the teeth.

### DETAILED DESCRIPTION OF THE DRAWINGS

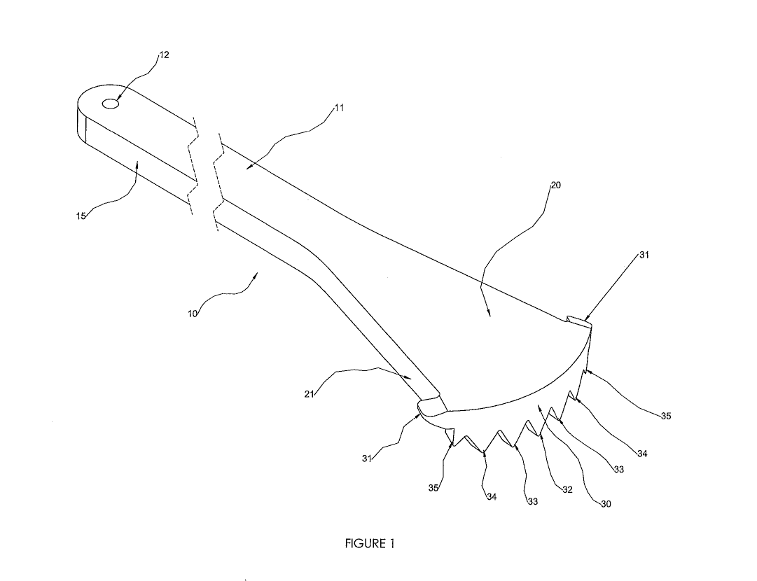

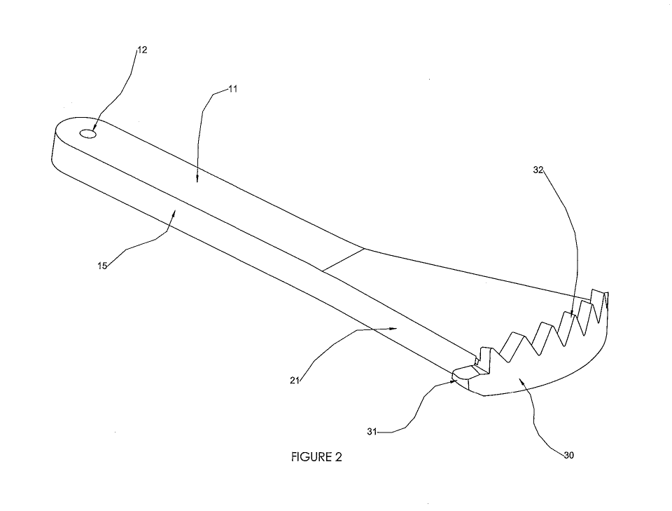

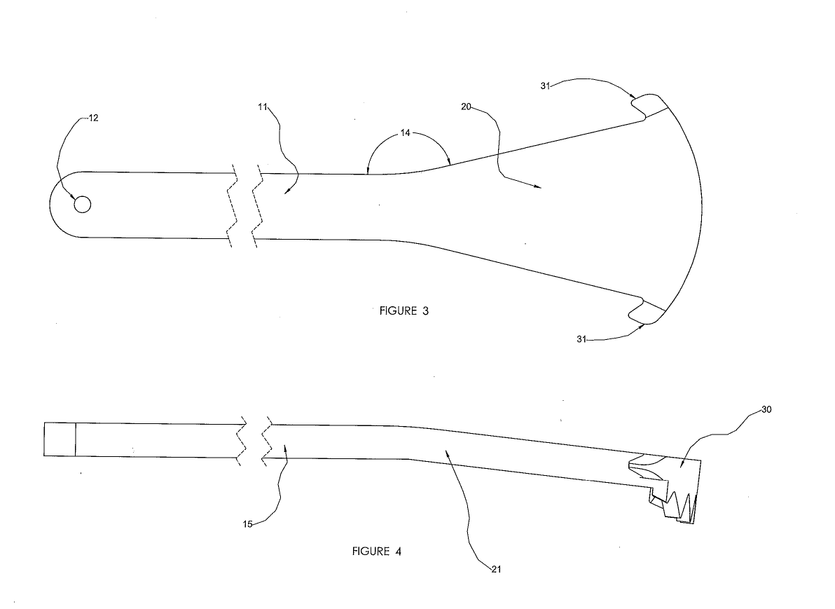

The present invention is referred to generally in FIGS. 1 to 6 by the reference numeral 10 and is intended to provide for an illustration for the construction of the therapeutic back scratcher and is the preferred embodiment. Like numbers refer to like elements throughout the figures.

This therapeutic back scratcher 10 includes an elongated stem section 11 of generally uniform cross section with thru hole 12 the base of the stem to allow the device to be conveniently hung on conventional retail store hooks. A generally pie-shaped scratching head 20, the distal end of with radius 22, is disposed of at its proximal end to the distal end of stem section 11. Side surfaces 15 and 21 are configured as such that angle 14 forms at their intersection ranging from 145° to 175° , most preferably 160°. Face 30 is perpendicular to the top surface of scratching head 20. Closely spaced teeth 32 to 35 protrude down from face 30 with tooth 32 being the longest at about 0.25 inches. Neighboring teeth 33 are about 5% to 15% shorter than tooth 32, most preferably about 10%. Neighboring teeth 34 are similarly about 5% to 15% shorter than teeth 33, most preferably about 10%. Neighboring teeth 35 are similarly about 5% to 15% shorter than teeth 34, most preferably about 10%. The sequence of teeth lengths form an arcuate pattern about radius 40 ranging from 1.5″ to 6″, most preferably 3″. The teeth are shaped with angle 36 ranging from 30° to 60°, most preferably 45° common among all with spacing 41 between them most preferred to be 0.25 inches. Side teeth 31 projecting out from front face 30 each similar in length as tooth 32. The thickness 29 of teeth 31 to 35 ranges from ⅛″ to ¼″, most preferably 3/16″. The unique ability to apply pressure with a single point using one of the side teeth 31 makes this a tool for reaching acupressure points on the human body, such as the back, that cannot be easily reached with the user's hand.

To aid in the ability to reach the scratching portion of one's back, the axial portion of stem section 11 and canted portion scratching head 20 meet at an obtuse angle 13 of from 0° to about 20°, most preferably about 10°.

In operation the therapeutic back scratcher stem section 11 is grasped by either the right or left hand and positioned over the shoulder such that any of the teeth 32 to 35 can be engaged with the region to be scratched or turning the device on its side such that tooth 31 applies therapeutic pressure to the region of interest. At their discretion, the user may move the device in a soothing motion to relieve the itch. Or if desired, slide side tooth 31 along the medial lines of the back for soothing therapeutic relief. Due to the varying length of teeth 32 to 35, the user may turn the therapeutic back scratcher slightly on its side so that the total pressure applied to the skin occurs through only those teeth which are engaged and not distributed throughout all teeth.

In a preferred embodiment, the use of the device is facilitated by constructing therapeutic back scratcher 10 in a monolithic fashion with durable lightweight materials such as ABS plastic. Stem section 11 is preferably of rectangular construction xx″ wide and xx″ thick with a semi-circular proximal end and a ⅛″ diameter thru hole to accommodate hanging from pegs in retail stores. Scratching head 20 is preferably of a pie-shaped construction, for example 1.25″ to 2.5″ wide, most preferably 1.5″, 1″ to 4″″ long, most preferably 3″, ⅜″ to ⅝″ thick, most preferably ½″, with front face of radius 22 ranging from 1″ to 2″, most preferably 1⅛″.

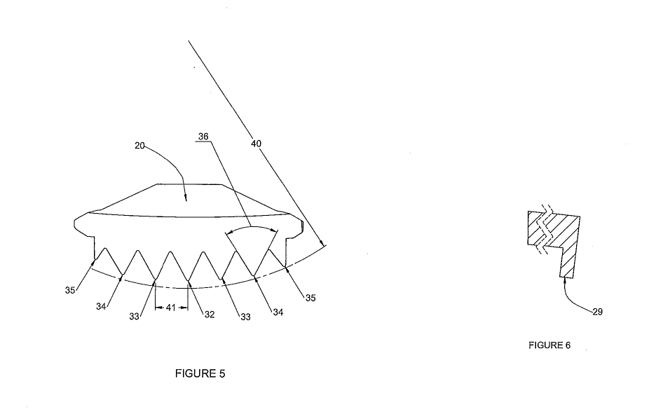

FIG. 5 depicts a novel feature of the TBS, specifically the various lengths of teeth 32 thru 35. The user can change the number of teeth applied to the back by rotating stem 11 which therein turn changes the angle of the scratching head with respect to the back. This configuration gives the user a way to scratch or apply pressure at a single pressure point to improve overall well being or to remove an itch that would still be there after a general massage of the back with seven teeth.

In use, the uniqueness of the design of head scratcher 20 incorporating a combination of radii 22 and 40 also allows the user to scratch an area to be itched by axially rotating stem 11 such that, one by one, teeth 32 thru 35 are spun over the desired location to provide relief.

The therapeutic back scratcher described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

I claim:

1. A therapeutic back scratcher comprising:
an elongated rectangular stem having an axial portion with a first free end and a second free end;
a scratcher head substantially pie-shaped in a solid planar manner consisting of top, bottom, side, and front surfaces, with proximal and distal ends where said front surface is concave in shape with respect to said stem axis forming said distal end, with said proximal end attached to said elongated stem second free end and positionally fixed in relation thereto;
a plurality of teeth extending orthogonally and in an arcuate shape from said bottom surface of said scratcher head distal end with length of said teeth being longest in the center and neighboring teeth decreasing in length symmetrically about said longest tooth until said scratcher head side surfaces are reached thereby providing for the scratching surfaces;
a singular side tooth protruding orthogonally from the distal end of each said side surface from said scratcher head providing for a point of applying pressure to surface to be therapeutically treated.

2. The therapeutic back scratcher in claim 1 where the bottom of said teeth are spaced about 0.25 inches apart.

3. The therapeutic back scratcher in claim 1 where the radius of said front surface concave shape is about 1.125 inches about the axial portion of said elongated stem.

4. The therapeutic back scratcher in claim 1 where the lateral distance between said distal ends of said scratcher head side surfaces is about 1.5 inches.

5. The therapeutic back scratcher in claim 1 where said plurality of teeth is about seven.

6. The therapeutic back scratcher in claim 1 where the number of said neighboring teeth is about three on each side of said center tooth.

7. The therapeutic back scratcher in claim 1 where length of said center tooth is about 0.25 inches.

8. The therapeutic back scratcher in claim 1 where length of said neighboring teeth from said center tooth are progressively 90% in length to that of their neighbor.

9. The therapeutic back scratcher in claim 1 where said side teeth extend out about 0.25 inches from the distal end of said scratcher head side surfaces.

10. The therapeutic back scratcher in claim 1 where said arcuate shape formed by the length of said teeth is along a radius of about 3 inches.
